(19) United States
(12) Patent Application Publication
(10) Pub. No.: US 2026/0200729 A1
(43) Pub. Date: Jul. 16, 2026

(54) SYSTEMS AND METHODS FOR SINGLE COLUMN REACTOR WITH FIXED BED AND FLUIDIZED BED CONFIGURATIONS

(71) Applicant: Ohio State Innovation Foundation, Columbus, OH (US)

(72) Inventors: Liang-Shih Fan, Columbus, OH (US); Danwyn J. Aranha, Columbus, OH (US)

(21) Appl. No.: 19/445,320

(22) Filed: Jan. 9, 2026

Related U.S. Application Data
(60) Provisional application No. 63/744,087, filed on Jan. 10, 2025.

(51) Int. Cl. C01B 3/28; C01B 32/40

(52) U.S. Cl. CPC C01B 3/28; C01B 32/40; C01B 2203/1241; C01B 2203/14; C01B 2203/169

(57) ABSTRACT

Exemplary systems and methods process carbonaceous materials with single column reactor systems. Broadly, exemplary methods include operating a single reactor system in a fixed bed configuration and in a fluidized bed configuration.

### CROSS-REFERENCE TO RELATED APPLICATIONS

This application claims priority to U.S. Provisional Patent Application No. 63/744,087, filed on Jan. 10, 2025, the entire contents of which are incorporated herein by reference.

### TECHNICAL FIELD

The present disclosure generally relates to processing carbonaceous materials with single column reactor systems. Exemplary methods and operating strategies involve a single reactor system with both fixed bed and fluidized bed configurations.

### INTRODUCTION

Chemical looping technology is one of the most promising technologies for fighting climate change with minimal environmental effects. Chemical looping technology comprises a reducer section, a regenerator section, and oxygen carrier particles, which donate lattice oxygen to the fuel. Oxygen carrier particles react with carbonaceous fuels, are reduced to a lower oxidation state, and generate chemicals such as syngas and hydrogen (H₂). Additionally, oxygen carrier particles react with air or steam (H₂O) to be regenerated by replenishing their lattice oxygen.

Fixed bed chemical looping systems have been widely used for chemical looping combustion, gasification, and reforming of different fuels. In a fixed bed chemical looping unit, the reducer and regenerator sections are in fixed bed form. In a first step, the reducing gases are sent into the fixed bed reactor to generate products. In a final step, the oxygen carrier particles are regenerated back to their fully oxidized form by sending air into the same fixed bed reactor.

Compared to moving bed and fluidized bed chemical looping systems, fixed bed chemical looping units are much simpler in design and have lower energy consumption due to the absence of moving parts and oxygen carrier particle movement. Fixed bed chemical looping units also have lower attrition of the oxygen carrier particles. On the other hand, the fixed bed process offers lower conversions with a higher probability of the materials sintering to each other due to them being fixed in a particular position. Further, over time, the fixed bed can suffer from channeling or uneven gas distributions and high-pressure drops due to the particles settling compactly, thereby reducing the available porosity for gas movement.

### SUMMARY

In some aspects, the techniques described herein relate to a method for operating a reactor, the method including: in a fixed bed operational configuration: providing a fuel stream to the reactor, the fuel stream including methane (CH₄), the reactor including oxygen carrier particles arranged as a fixed bed, where the fuel stream is provided such that the fuel stream contacts the oxygen carrier particles, thereby reducing the oxygen carrier particles; collecting a first fixed bed configuration output including carbon dioxide (CO₂) and steam (H₂O); monitoring a target species purity in the first fixed bed configuration output; and when the target species purity drops below a first threshold value of 85% purity, switching to a fluidized bed operational configuration; after operating in the fixed bed operational configuration, in the fluidized bed operational configuration: providing a fluidizing stream to the reactor, the fluidizing stream including air, the fluidizing stream being provided such that the oxygen carrier particles form a fluidized bed in the reactor, whereupon the oxygen carrier particles are oxidized by the fluidizing stream; collecting a fluidized bed configuration output including oxygen-depleted air; monitoring oxygen (O₂) content in the fluidized bed configuration output; and when the oxygen (O₂) content is above a second threshold value of 75%, switching to the fixed bed operational configuration.

In some aspects, the techniques described herein relate to a reactor system, including: a reactor having a fixed bed operational configuration and a fluidized bed operational configuration, the reactor including: particles that are oxygen carrier particles or inert particles arranged as a fixed bed during the fixed bed operational configuration; wherein the fixed bed occupies between 40 volume percent (vol %) and 60 vol % of an inner volume of the reactor; a fuel stream inlet configured to receive fuel from a fuel stream input source; a first outlet configured to provide a first output stream during the fixed bed operational configuration; a fluidizing stream inlet configured to receive a fluidizing stream from a fluidizing stream input source; and a second outlet configured to provide a second output stream during the fluidized bed operational configuration.

In some aspects, the techniques described herein relate to a method for operating a reactor, the method including: in a fixed bed operational configuration: providing a fuel stream to the reactor, the fuel stream including methane (CH₄) and/or a solid carbonaceous fuel, the reactor including inert particles; collecting a first fixed bed configuration output including hydrogen (H₂) and/or carbonaceous volatiles; monitoring a target species purity in the first fixed bed configuration output; and when the target species purity drops below a first threshold value of 85% purity, switching to a fluidized bed operational configuration; after the fixed bed operational configuration, in the fluidized bed operational configuration: providing a fluidizing stream to the reactor, such that the fluidizing stream fluidizes the inert particles and carbonaceous material on the inert particles is oxidized; the fluidizing stream including air, and collecting a fluidized bed configuration output including air, oxygen-depleted air, carbon dioxide (CO₂), and/or char; monitoring a second target species content in the fluidized bed configuration output; and when the second target species content deviates from a second threshold value, switching to the fixed bed operational configuration.

### BRIEF DESCRIPTION OF THE DRAWINGS

FIG. 1A is a schematic diagram of an exemplary reactor system in an exemplary fixed bed operational configuration. FIG. 1B is a schematic diagram of the exemplary reactor system of FIG. 1A in an exemplary fluidized bed operational configuration.

FIG. 2A is a schematic diagram of an exemplary first fixed bed operational configuration of an exemplary reactor system. FIG. 2B is a schematic diagram of an exemplary second fixed bed operational configuration of the exemplary reactor system in FIG. 2A. FIG. 2C is a schematic diagram of an exemplary third fixed bed operational configuration of exemplary reactor system in FIG. 2A. FIG. 2D is a schematic diagram of an exemplary fluidized bed operational configuration of the exemplary reactor system in FIG. 2A.

FIG. 3A is a schematic diagram of an exemplary first fixed bed operational configuration of an exemplary reactor system. FIG. 3B is a schematic diagram of an exemplary second fixed bed operational configuration of the exemplary reactor system in FIG. 3A. FIG. 3C is a schematic diagram of an exemplary third fixed bed operational configuration of the exemplary reactor system in FIG. 3A. FIG. 3D is a schematic diagram of an exemplary fluidized bed operational configuration of the exemplary reactor system in FIG. 3A.

FIG. 4A is a schematic diagram of an exemplary fixed bed operational configuration of an exemplary reactor system. FIG. 4B is a schematic diagram of an exemplary fluidized bed operational configuration of the exemplary reactor system in FIG. 4A.

FIG. 5A is a schematic diagram of an exemplary first fixed bed operational configuration of an exemplary reactor system. FIG. 5B is a schematic diagram of an exemplary second fixed bed operational configuration of the exemplary reactor system in FIG. 5A. FIG. 5C is a schematic diagram of an exemplary fluidized bed operational configuration of the exemplary reactor system in FIG. 5A.

FIG. 6A is a schematic diagram of an exemplary fixed bed operational configuration of an exemplary reactor system. FIG. 6B is a schematic diagram of an exemplary fluidized bed operational configuration of the exemplary reactor system in FIG. 6A.

FIG. 7A is a schematic diagram of an exemplary fixed bed operational configuration of an exemplary reactor system. FIG. 7B is a schematic diagram of an exemplary fluidized bed operational configuration of the exemplary reactor system in FIG. 7A.

FIG. 8 illustrates a plot of pressure drop (dP, in inches of water) across a reactor in hot conditions as a function of flow rate (slpm).

FIG. 9 illustrates a plot of pressure drop (dP, in inches of water) across a reactor with particles in hot conditions as a function of flow rate (slpm).

FIG. 10 illustrates a plot of pressure drop (dP, in inches of water) across a bed with particles in hot conditions as a function of flow rate (slpm).

FIG. 11 shows a plot of gas concentration (%) as a function of time during the operation of an experimental reactor system at 900° C.

FIG. 12 shows a plot of gas concentration (%) as a function of time during the operation of an experimental reactor system at 950° C.

### DETAILED DESCRIPTION

Broadly, exemplary systems and methods relate to a reactor configured for both fixed bed operation and fluidized bed operation. Exemplary systems and methods may be used to process methane (CH₄) or solid carbonaceous fuel.

Generally, in fixed bed chemical looping units, reducer and regenerator sections can be in fixed bed form. Broadly, one operation may include providing reducing gases into a fixed bed reactor, thereby reducing oxygen carrier particles and generating products. Broadly, another operation may include regenerating oxygen carrier particles by sending air into the same fixed bed reactor, thereby oxidizing oxygen carrier particles back to their fully oxidized form.

The present application replaces the fixed bed regeneration step with a fluidized bed regeneration operation, creating a fixed bed reducer and fluidized bed regenerator system using a single reactor column. The combination of fixed bed reduction and fluidized bed regeneration is used herein to realize benefits of both fixed and fluidized beds. As non-limiting examples, exemplary benefits may include reducing particle sintering and enabling the use of solid carbonaceous fuels in a fixed-bed reactor to be feasible.

### I. Definitions

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number therebetween with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

A “moving bed reactor” is defined as a reactor where particles flow in a single direction, generally, from top to bottom. The fluid material can flow in the same direction as the particles (co-current movement). The fluid material can flow in an opposite direction as the particles (countercurrent movement).

A “fluidized bed reactor” is defined as a reactor where fluid is passed through particles at a sufficient speed to suspend the solid particles. Typically, particles may move in any direction, bounded by the walls of the reactor.

A “fixed bed reactor” is defined as a reactor where particles are fixed in a packed bed. Fluid is passed through particles, but the fluid does not suspend the particles, as in a fluidized bed reactor.

### II. Exemplary Materials

Exemplary systems, methods, and techniques disclosed and contemplated herein may use and generate various materials. Exemplary materials include particles, input streams, and outputs. Various aspects of each are described below.

### A. Exemplary Particles

Various exemplary implementations may use either oxygen carrier particles or inert particles.

Exemplary oxygen carrier particles may include one or more active metal oxides. In some instances, exemplary metal oxide composites may have at least one of the active metals as iron (Fe). Exemplary metal oxide composites may be a single phase or a mixture of multiple active phases. In various instances, the metal oxide composite comprises more than one active metal capable of undergoing a change in oxidation state under reducing or oxidizing conditions, or a phase change under a partial pressure of carbon dioxide (CO₂).

Exemplary oxygen carrier particles may comprise iron oxide (Fe₂O₃), copper oxide (CuO), nickel oxide (NiO), manganese oxide (Mn₂O₃), cerium oxide (CeO₂), cobalt oxide (Co₃O₄), tungsten oxide (WO₃), vanadium oxide (V₂O₅), calcium and iron oxide (Ca₂Fe₂O₅), or combinations thereof.

Further, exemplary oxygen carrier particles may be characterized by their degree of reduction or oxidation. For example, a higher degree of reduction indicates a more reduced state of oxygen carrier particles. For example, when the oxygen carrier particles comprise Fe₂O₃, the lowest degree of reduction (or highest degree of oxidation) corresponds to a fully oxidized state (Fe₂O₃), while the highest degree of reduction (lowest degree of oxidation) corresponds to a fully reduced state (metallic Fe).

The recyclability of exemplary metal oxide particles may be promoted by adding supportive oxides, also termed support materials, which may also affect the lattice oxygen ion diffusivity. The support material may be any support material known and used in the art. Non-limiting examples of support materials include, but are not limited to, silica (SiO₂), magnesia (MgO), alumina (Al₂O₃), ceria (CeO₂), titania (TiO₂), zirconia (ZrO₂), or a combination comprising two or more of the aforementioned supports, such as magnesium aluminate spinel (MgAl₂O₄).

The amount of support material may be 20 wt % to 80 wt % of the metal oxide particle. In various implementations, exemplary metal oxide particles may comprise 20 wt % to 80 wt %; 25 wt % to 75 wt %; 30 wt % to 70 wt %; 35 wt % to 65 wt %; 40 wt % to 60 wt %; 45 wt % to 55 wt %; 50 wt % to 80 wt %; 20 wt % to 50 wt %; 25 wt % to 50 wt %; or 30 wt % to 50 wt % support material. In some instances, the amount of support material may be no greater than 80 wt %; no greater than 75 wt %; no greater than 70 wt %; no greater than 65 wt %; no greater than 60 wt %; no greater than 55 wt %; or no greater than 50 wt %. In some instances, the amount of support material may be no less than 20 wt %; no less than 25 wt %; no less than 30 wt %; no less than 35 wt %; no less than 40 wt %; or no less than 45 wt %.

Inert carbonate materials such as potassium carbonate (K₂CO₃) may also be included as a part of the overall composite solid which may later combine with the carbonate phase to form a mixed metal carbonate.

In some implementations, the reactivity of metal oxide particles may be enhanced by low-concentration dopant modification. One or more dopants may comprise 0 wt % to about 5 wt % of the oxygen carrier particles. In various instances, metal oxide particles may comprise 0 wt % to 5 wt %; 0.5 wt % to 5 wt %; 1 wt % to 5 wt %; 1.5 wt % to 5 wt %; 2 wt % to 5 wt %; 2.5 wt % to 5 wt %; 3 wt % to 5 wt %; 3.5 wt % to 5 wt %; 4 wt % to 5 wt %; 0.5 wt % to 4.5 wt %; 1 wt % to 4 wt %; 1 wt % to 3 wt %; 1 wt % to 2 wt %; 2 wt % to 3 wt %; 2.5 wt % to 3.5 wt %; 3 wt % to 4 wt %; or 4 wt % to 4.5 wt % dopant. In some instances, the dopant concentration may be no greater than 5 wt %; no greater than 4.5 wt %; no greater than 4 wt %; no greater than 3.5 wt %; no greater than 3 wt %; or no greater than 2 wt %. In some instances, the dopant concentration may be no less than 0.5 wt %; no less than 1 wt %; no less than 1.5 wt %; no less than 2 wt %; no less than 2.5 wt %; or no less than 3 wt %.

Exemplary dopants may have one or more of the following impacts in reactivity enhancement of cyclic chemical looping redox reactions. Exemplary catalytic dopants may provide extra reaction sites during CO₂ capture and hydrocarbon conversion in addition to the host transition metal oxide particles, such as iron oxide. The nature of aliovalent dopants, such as Cu²⁺, Co²⁺, Ni²⁺ vs Fe³⁺, may result in an increase of oxygen vacancies, which may promote oxygen ion transport in methane partial oxidation and improve syngas quality. Exemplary catalytic dopants may lower the reaction energy barrier of CO₂ capture and C-H activation with the host transition metal oxide particles.

Example catalytic transition metal dopants include, but are not limited to, nickel (Ni), cobalt (Co), copper (Cu), scandium (Sc), titanium (Ti), vanadium (V), chromium (Cr), manganese (Mn), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), lutetium (Lu), hafnium (Hf), tantalum (Ta), tungsten (W), rhenium (Re), osmium (Os), iridium (Ir), platinum (Pt), and gold (Au).

Exemplary inert particles are not reactants in either reduction or oxidation reactions. Exemplary inert particles may comprise SiO₂, Al₂O₃, aluminosilicates, kaolin, mullite, alumina-zirconia-silica, CaAl₂O₄, CaAl₄O₇, or combinations thereof.

In some implementations, oxygen carrier particles or inert particles may comprise D_{V}90 sizes between 1.00 mm and 2.00 mm; 1.13 mm and 2.00 mm; 1.25 mm and 2.00 mm; 1.38 mm and 2.00 mm; 1.50 mm and 2.00 mm; 1.63 mm and 2.00 mm; 1.75 mm and 2.00 mm; 1.88 mm and 2.00 mm; 1.00 mm and 1.88 mm; 1.00 mm and 1.75 mm; 1.00 mm and 1.63 mm; 1.00 mm and 1.50 mm; 1.00 mm and 1.38 mm; 1.00 mm and 1.25 mm; or 1.00 mm and 1.13 mm. In some implementations, oxygen carrier particles or inert particles may comprise D_{V}90 sizes no less than 1.00 mm; no less than 1.13 mm; no less than 1.25 mm; no less than 1.38 mm; no less than 1.50 mm; no less than 1.63 mm; no less than 1.75 mm; no less than 1.88 mm; or no less than 2.00 mm. In some implementations, oxygen carrier particles or inert particles may comprise D_{V}90 sizes no greater than 2.00 mm; no greater than 1.88 mm; no greater than 1.75 mm; no greater than 1.63 mm; no greater than 1.50 mm; no greater than 1.38 mm; no greater than 1.25 mm; no greater than 1.13 mm; or no greater than 1.00 mm. In some implementations, oxygen carrier particles or inert particles may comprise D_{V}90 size of approximately 1.5 mm.

### B. Exemplary Input Streams

Exemplary reactors described herein may be configured to receive various input streams. The selection of input streams may depend on factors such as reaction requirements and overall process conditions. Exemplary input streams comprise fuel streams, gasification input streams, oxidation streams, fluidizing streams, and barrier streams.

Exemplary fuel streams may comprise methane (CH₄) or solid carbonaceous fuel.

Solid carbonaceous fuel may comprise biomass, plastics, coal, municipal solid waste, or combinations thereof.

Exemplary gasification input streams may comprise carbon dioxide (CO₂) and methane (CH₄) or carbon dioxide (CO₂) and water (H₂O).

As used herein, the term “oxidizing stream” refers to any gaseous species capable of donating or supplying oxygen to a material, thereby increasing its oxidation state. Exemplary oxidation streams may comprise molecular oxygen (O₂), air, steam (H₂O), carbon dioxide (CO₂), and combinations thereof.

Exemplary fluidizing streams may comprise air. Air may comprise nitrogen (N₂), oxygen (O₂), and argon (Ar).

Exemplary barrier streams comprise inert gas. As used herein, the term “inert gas” refers to any gaseous species that does not participate in oxidation or reduction reactions under process conditions. Exemplary inert gas may comprise nitrogen (N₂), argon (Ar), neon (Ne), helium (He), or combinations thereof. In some instances, exemplary inert gas may comprise nitrogen (N₂).

### C. Exemplary Outputs

Exemplary outputs comprise fixed bed configuration outputs, fluidized bed configuration outputs, and bio-oil.

Exemplary fixed bed configuration outputs may comprise a first, a second, and a third fixed bed configuration output.

A first fixed bed configuration output may comprise carbon dioxide (CO₂) and steam (H₂O) or may comprise hydrogen (H₂) and/or carbonaceous volatiles.

Exemplary carbonaceous volatiles may comprise carbonaceous matter in a gaseous or liquid aerosol state.

A second fixed bed configuration output may comprise carbon monoxide (CO) or carbon monoxide (CO) and hydrogen (H₂).

A third fixed bed configuration output may comprise hydrogen (H₂).

Exemplary fluidized bed configuration outputs may comprise air, carbon dioxide (CO₂), char, or oxygen-depleted air. Air is described above. In some instances, char includes biochar. Oxygen-depleted air comprises air depleted of oxygen (O₂).

In some instances, oxygen-depleted air may comprise between 3% oxygen (O₂) and 5% oxygen (O₂) by volume. In various implementations, oxygen-depleted air may comprise oxygen (O₂) having a vol % between 3.00% and 5.00%; 3.25% and 5.00%; 3.50% and 5.00%; 3.75% and 5.00%; 4.00% and 5.00%; 4.25% and 5.00%; 4.50% and 5.00%; 4.75% and 5.00%; 3.00% and 4.75%; 3.00% and 4.50%; 3.00% and 4.25%; 3.00% and 4.00%; 3.00% and 3.75%; 3.00% and 3.50%; or 3.00% and 3.25%. In various implementations, oxygen-depleted air may comprise oxygen (O₂) having a vol % no less than 3.00%; no less than 3.25%; no less than 3.50%; no less than 3.75%; no less than 4.00%; no less than 4.25%; no less than 4.50%; no less than 4.75%; or no less than 5.00%. In various implementations, oxygen-depleted air may comprise oxygen (O₂) having a vol % no greater than 5.00%; no greater than 4.75%; no greater than 4.50%; no greater than 4.25%; no greater than 4.00%; no greater than 3.75%; no greater than 3.50%; no greater than 3.25%; or no greater than 3.00%.

Broadly, bio-oil comprises a broad range of compositions related to the specific solid carbonaceous fuel pyrolyzed and the specific pyrolysis conditions used. Exemplary bio-oil comprises a mixture of non-volatile organic compounds. Exemplary bio-oil may comprise a viscous liquid comprising numerous oxygenated organic compounds and water. Exemplary oxygenated organic compounds may comprise aldehydes, ketones, esters, carboxylic acids, phenols, furans, and/or sugars. In some instances, bio-oil may be acidic.

### III. Exemplary Systems

Various systems may be used to perform exemplary methods and techniques described herein. Various aspects of exemplary reactor systems are described below.

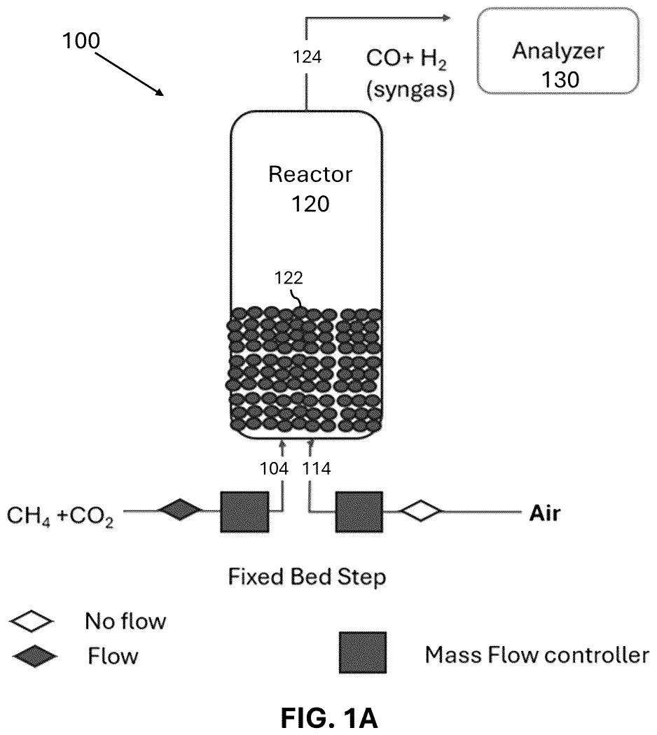

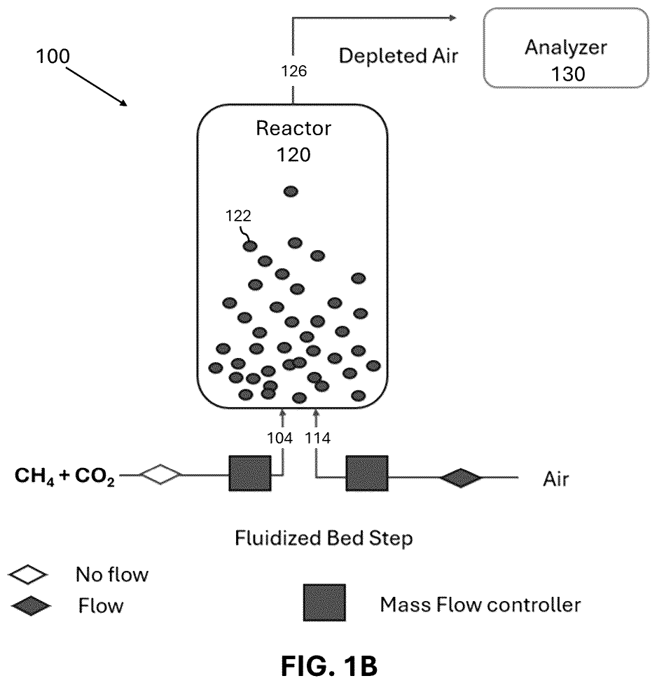

FIGS. 1A-1B schematically depict an exemplary reactor system 100. Reactor system 100 may be particularly suited for processing methane (CH₄) and solid carbonaceous fuel and generating carbon monoxide (CO), hydrogen (H₂), carbon dioxide (CO₂), steam (H₂O), carbonaceous volatiles, bio-oil, or char. As shown, exemplary reactor system 100 comprises reactor 120, analyzer 130, first input stream 104, second input stream 114, and output streams 124 and 126. Further, reactor 120 comprises particles 122. Other embodiments may include more or fewer components.

Reactor 120 may operate in a fixed bed operational configuration (FIG. 1A) and in a fluidized bed operational configuration (FIG. 1B). In a fixed bed operational configuration, reactor 120 comprises oxygen carrier particles, or inert particles, arranged as a fixed bed.

During fixed bed operation of reactor 120, the fixed bed occupies between 40 volume percent (vol %) and 60 vol % of an inner volume of reactor 120. In various implementations, the fixed bed may occupy 40 vol % to 60 vol %; 42 vol % to 58 vol %; 45 vol % to 55 vol %; 48 vol % to 52 vol %; 40 vol % to 50 vol %; or 50 vol % to 60 vol % of the inner volume of reactor 120. In some instances, the fixed bed may occupy no greater than 60 vol %; no greater than 58 vol %; no greater than 55 vol %; or no greater than 50 vol % of the inner volume of reactor 120. In some instances, the fixed bed may occupy no less than 40 vol %; no less than 42 vol %; no less than 45 vol %; or no less than 48 vol % of the inner volume of reactor 120.

In some implementations of fixed bed operation, oxygen carrier particles or inert particles may comprise a voidage between particles between 0.35 and 0.45; 0.36 and 0.45; 0.38 and 0.45; 0.38 and 0.42; 0.39 and 0.45; 0.40 and 0.45; 0.41 and 0.45; 0.43 and 0.45; 0.44 and 0.45; 0.35 and 0.44; 0.35 and 0.43; 0.35 and 0.41; 0.35 and 0.40; 0.35 and 0.39; 0.35 and 0.38; or 0.35 and 0.36. In some implementations, oxygen carrier particles or inert particles may comprise a voidage between particles no less than 0.35; no less than 0.36; no less than 0.38; no less than 0.39; no less than 0.40; no less than 0.41; no less than 0.43; no less than 0.44; or no less than 0.45. In some implementations, oxygen carrier particles or inert particles may comprise a voidage between particles no greater than 0.45; no greater than 0.44; no greater than 0.43; no greater than 0.41; no greater than 0.40; no greater than 0.39; no greater than 0.38; no greater than 0.36; or no greater than 0.35.

In some instances, reactor 120 is in fluid communication with a condenser unit (not shown). Exemplary condenser units may be configured to cool and condense vapor-phase components of streams exiting the reactor, thereby converting at least a portion of the vapor to liquid for subsequent collection, separation, recycle, or downstream processing.

Exemplary reactor 120 comprises a fuel stream inlet configured to receive fuel from a fuel stream input source, such as first input stream 104. Exemplary reactor 120 comprises a fluidizing stream inlet configured to receive a fluidizing stream from a fluidizing stream input source, such as second input stream 114. Details regarding exemplary reactor input streams are provided above.

A first outlet of exemplary reactor 120 may be configured to provide a first output stream, such as output stream 124, during the fixed bed operational configuration. Further, a second outlet of exemplary reactor 120 may be configured to provide a second output stream, such as output stream 126, during the fluidized bed operational configuration. Details regarding exemplary reactor output streams are provided above.

In some implementations, the reactor 120 further comprises a gasification stream inlet configured to receive a gasification stream from a gasification input source. In some implementations, the reactor 120 further comprises an oxidation stream inlet configured to receive an oxidation stream from an oxidation stream source.

In some implementations, reactor 120 further comprises a barrier stream inlet configured to receive a barrier stream from a barrier stream source.

In some implementations, reactor system 100 further comprises a condenser configured to receive a fixed bed configuration output stream and configured to provide bio-oil.

In some implementations, reactor system 100 comprises an analyzer unit in communication with the first outlet and the second outlet. The analyzer unit is configured to determine concentrations of one or more target species in the first output stream and/or the second output stream.

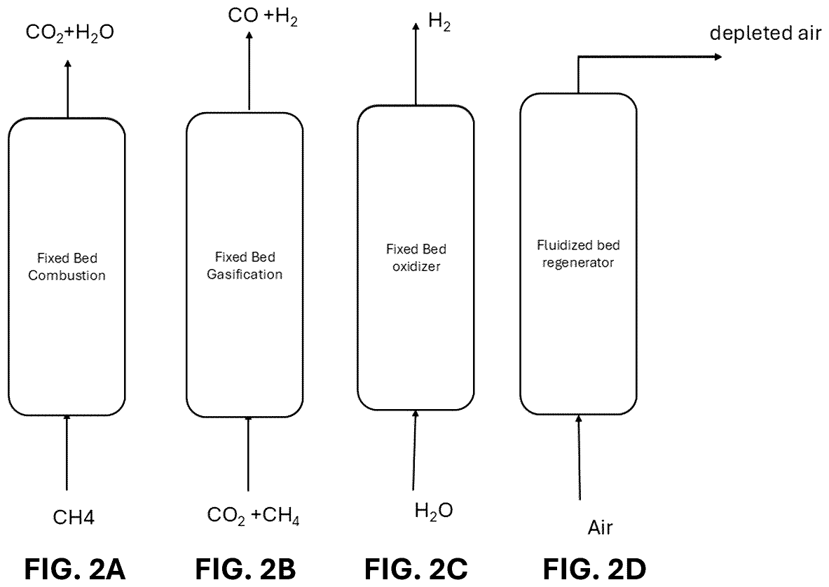

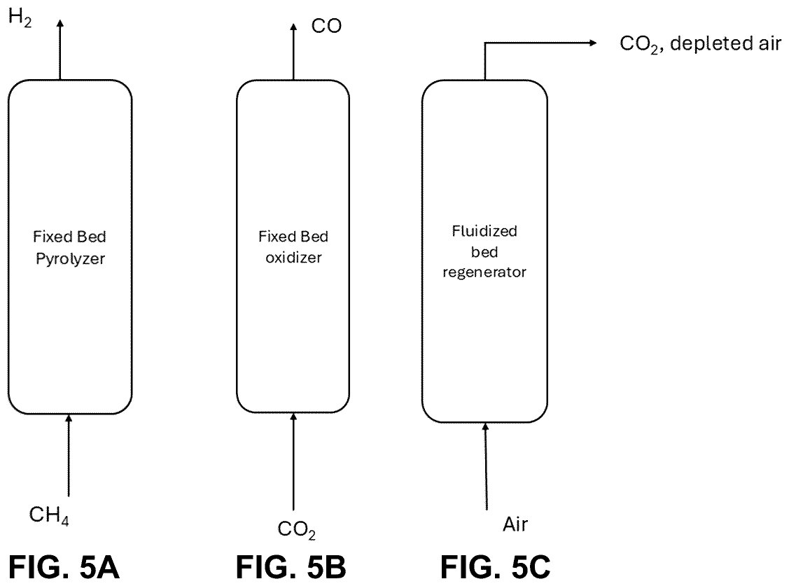

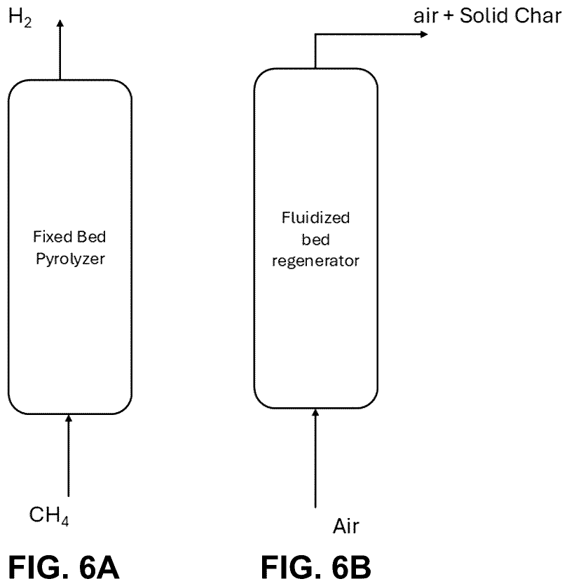

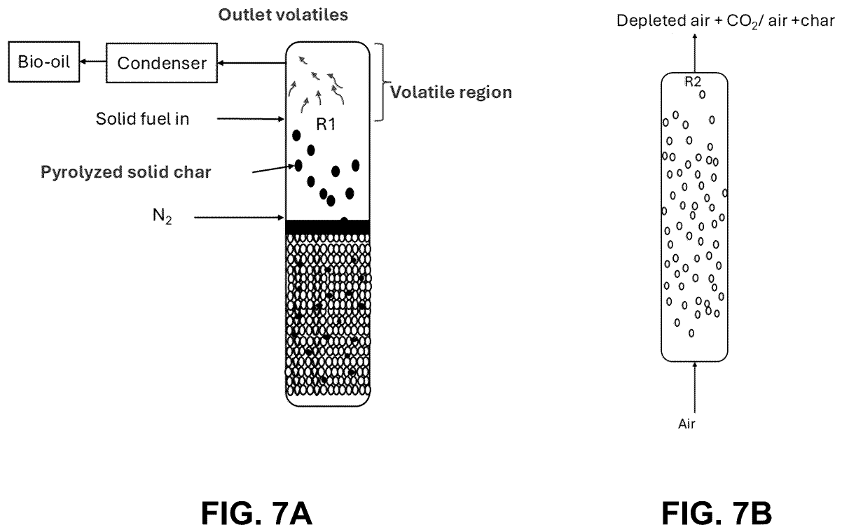

FIGS. 2-7 schematically depict exemplary operational configurations for exemplary reactor system 100. FIGS. 2A-4B schematically depict an exemplary operational configuration using oxygen carrier particles and a methane (CH₄) fuel, FIGS. 5A-6B schematically depict another exemplary operational configuration using inert particles and a methane (CH₄) fuel, and FIGS. 7A-7B schematically depicts another exemplary operational configuration using inert particles and solid carbonaceous fuel. Details regarding exemplary reactor input and output streams are provided above.

FIGS. 2A-2D schematically depict an exemplary operational configuration of reactor system 100, wherein the fixed bed operational configuration comprises three stages. FIG. 2A schematically depicts an exemplary first stage of the fixed bed operational configuration, which comprises reducing oxygen carrier particles using a fuel stream, such as methane (CH₄), and generating carbon dioxide (CO₂) and steam (H₂O). FIG. 2B schematically depicts an exemplary second stage of the fixed bed operational configuration, which comprises further reducing oxygen carrier particles using a gasification input stream, such as carbon dioxide (CO₂) and methane (CH₄), and generating a syngas stream of carbon monoxide (CO) and hydrogen (H₂). FIG. 2C schematically depicts an exemplary third stage of the fixed bed operational configuration, which comprises oxidizing the oxygen carrier particles using an oxidation stream such as steam (H₂O) and generating hydrogen (H₂).

FIG. 2D schematically depicts an exemplary fluidized bed operational configuration, which comprises further oxidizing oxygen carrier particles using air and generating oxygen-depleted air. During the fluidized bed operational configuration, the oxygen carrier particles are fluidized and form a fluidized bed. Other embodiments may include variations in the order of operation.

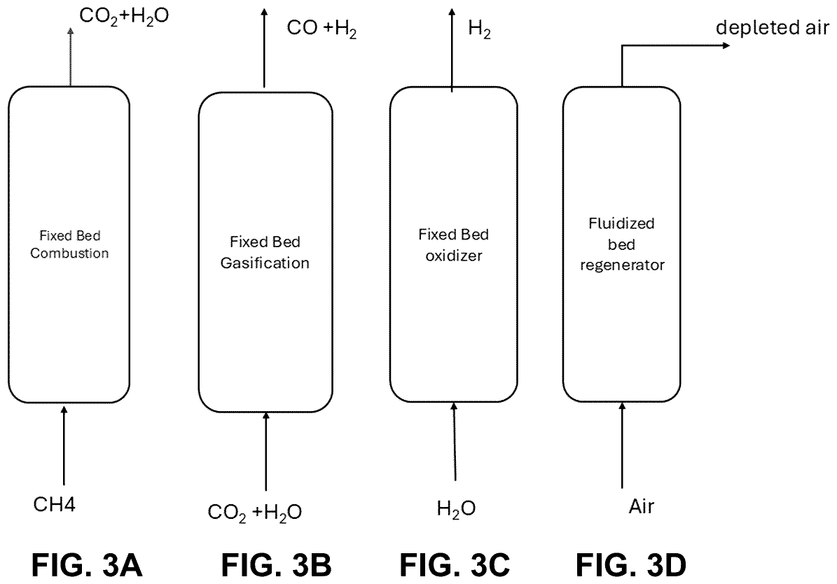

FIGS. 3A-3D schematically depict another exemplary operational configuration of reactor system 100, wherein the fixed bed operational configuration comprises three stages. FIG. 3A schematically depicts an exemplary first stage of the fixed bed operational configuration, which comprises reducing oxygen carrier particles using a fuel stream, such as methane (CH₄), and generating carbon dioxide (CO₂) and steam (H₂O). FIG. 3B schematically depicts an exemplary second stage of the fixed bed operational configuration, which comprises further reducing oxygen carrier particles using a gasification input stream, such as carbon dioxide (CO₂) and steam (H₂O), and generating a syngas stream of carbon monoxide (CO) and hydrogen (H₂). FIG. 3C schematically depicts an exemplary third stage of the fixed bed operational configuration, which comprises oxidizing the oxygen carrier particles using an oxidation stream such as steam (H₂O) and generating hydrogen (H₂).

FIG. 3D schematically depicts an exemplary fluidized bed operational configuration, which comprises further oxidizing oxygen carrier particles using air and generating oxygen-depleted air. During the fluidized bed operational configuration, the oxygen carrier particles are fluidized and form a fluidized bed. Other embodiments may include variations in the order of operation.

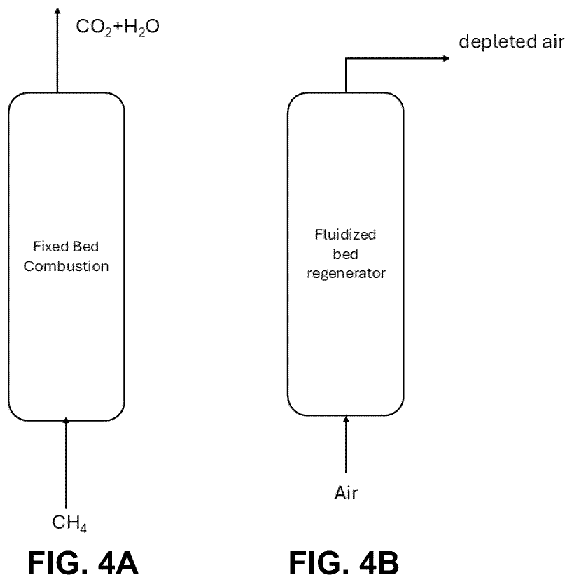

FIGS. 4A-4B schematically depict another exemplary operational configuration of reactor system 100, wherein the fixed bed operational configuration comprises one stage. FIG. 4A schematically depicts an exemplary stage of the fixed bed operational configuration, which comprises reducing oxygen carrier particles using a fuel stream, such as methane (CH₄), and generating carbon dioxide (CO₂) and steam (H₂O). FIG. 4B schematically depicts an exemplary fluidized bed operational configuration, which comprises further oxidizing oxygen carrier particles using air and generating oxygen-depleted air. During the fluidized bed operational configuration, the inert particles are fluidized and form a fluidized bed.

FIG. 5A-5C schematically depict another exemplary operational configuration of reactor system 100, wherein the fixed bed operational configuration comprises two stages. FIG. 5A schematically depicts an exemplary first stage of the fixed bed operational configuration, which comprises pyrolyzing methane (CH₄) over inert particles and generating hydrogen (H₂). FIG. 5B schematically depicts an exemplary second stage of the fixed bed operational configuration, which comprises oxidizing carbonaceous material on the inert particles using an oxidation stream such as carbon dioxide (CO₂) and generating carbon monoxide (CO).

FIG. 5C schematically depicts an exemplary fluidized bed operational configuration, and during this configuration, the inert particles are fluidized using air to form a fluidized bed. Carbonaceous material, or char, deposited on the inert particles is removed due to the turbulence associated with the fluidization. Consequently, fluidization generates oxygen-depleted air and char or carbon dioxide (CO₂). In some implementations, at sufficiently elevated fluidized bed temperatures, carbonaceous material, or char, is oxidized, thereby generating carbon dioxide (CO₂). Furthermore, in some implementations, the char can be separated from oxygen-depleted air using a cyclone separator.

FIG. 6A-6B schematically depicts another exemplary operational configuration of reactor system 100, wherein the fixed bed operational configuration comprises one stage. FIG. 6A schematically depicts an exemplary stage of the fixed bed operational configuration, which comprises pyrolyzing methane (CH₄) over inert particles and generating hydrogen (H₂).

FIG. 6B schematically depicts an exemplary fluidized bed operational configuration, and during this configuration, the inert particles are fluidized using air to form a fluidized bed. Carbonaceous material, or char, deposited on the inert particles is removed due to the turbulence associated with the fluidization. Fluidization generates oxygen-depleted air and char. In some implementations, the char can be separated from oxygen-depleted air using a cyclone separator.

FIG. 7A-7B schematically depicts another exemplary operational configuration of reactor system 100, wherein the fixed bed operational configuration comprises one stage. FIG. 7A schematically depicts an exemplary stage of the fixed bed operational configuration, which comprises pyrolyzing solid carbonaceous fuel over inert particles and generating carbonaceous volatiles.

FIG. 7B schematically depicts an exemplary fluidized bed operational configuration, and during this configuration, the inert particles are fluidized using air to form a fluidized bed. Carbonaceous material, or char, deposited on the inert particles is removed due to the turbulence associated with the fluidization. Additionally, carbonaceous material, or char, deposited on the inert particles may be oxidized by the air. Fluidization generates carbon dioxide (CO₂) and oxygen-depleted air or air and char. In some implementations, the char can be separated from oxygen-depleted air using a cyclone separator.

### IV. Exemplary Methods

Various methods may be employed to operate exemplary reactor systems contemplated herein. Broadly, example methods may comprise operating reactor system in a fixed bed operational configuration and a fluidized bed operational configuration. Other embodiments may include more or fewer operations than those discussed below, and many aspects are discussed above with reference to FIG. 1A-FIG. 7B.

### A. Fixed Bed Operation

Operating a reactor in a fixed bed operational configuration may begin by providing a fuel stream to a reactor. The fuel stream comprises methane (CH₄) and the reactor system may comprise oxygen carrier particles arranged as a fixed bed. The fuel stream may be provided such that the fuel stream contacts oxygen carrier particles, thereby reducing the oxygen carrier particles.

Example methods may include collecting a first fixed bed configuration output comprising carbon dioxide (CO₂) and steam (H₂O). Exemplary methods may include monitoring a target species purity in the first fixed bed configuration output. When the target species purity drops below a first threshold value of 85% purity, exemplary methods may switch to a fluidized bed operational configuration.

In another implementation, operating a reactor in a fixed bed operational configuration may begin by providing a fuel stream to the reactor system, the fuel stream comprising methane (CH₄) or solid carbonaceous fuel. The reactor may comprise inert particles, arranged as a fixed bed. The fuel stream may be provided such that the fuel stream contacts inert particles or such that the fuel stream enters above inert particles. Additionally, during the fixed bed operational configuration, example methods include providing a barrier stream adjacent to an interface of a pyrolyzing region and a gasifying region of the reactor. As discussed in greater detail above, the barrier stream comprises inert gas. Exemplary methods may include collecting a first fixed bed configuration output comprising hydrogen (H₂) or carbonaceous volatiles.

Exemplary methods may include monitoring a target species purity in the first fixed bed configuration output. When the target species purity drops below a first threshold value of purity, exemplary methods may switch to a fluidized bed operational configuration.

The target species may comprise one or more of: carbon dioxide (CO₂), steam (H₂O), carbon monoxide (CO), or hydrogen (H₂). In some implementations, the first threshold value may be a purity with a volume percent (vol %) between 75.0 vol % and 100.0 vol %; 78.1 vol % and 100.0 vol %; 81.3 vol % and 100.0 vol %; 84.4 vol % and 100.0 vol %; 87.5 vol % and 100.0 vol %; 90.6 vol % and 100.0 vol %; 93.8 vol % and 100.0 vol %; 96.9 vol % and 100.0 vol %; 75.0 vol % and 96.9 vol %; 75.0 vol % and 93.8 vol %; 75.0 vol % and 90.6 vol %; 75.0 vol % and 87.5 vol %; 75.0 vol % and 84.4 vol %; 75.0 vol % and 81.3 vol %; or 75.0 vol % and 78.1 vol %. In some implementations, the first threshold value may comprise a purity with a volume percent (vol %) of no less than 75.0 vol %; no less than 78.1 vol %; no less than 81.3 vol %; no less than 84.4 vol %; no less than 87.5 vol %; no less than 90.6 vol %; no less than 93.8 vol %; no less than 96.9 vol %; or no less than 100.0%. In some implementations, the first threshold value may comprise a purity with a volume percent (vol %) of no greater than 100.0 vol %; no greater than 96.9 vol %; no greater than 93.8 vol %; no greater than 90.6 vol %; no greater than 87.5 vol %; no greater than 84.4 vol %; no greater than 81.3 vol %; no greater than 78.1 vol %; or no greater than 75.0 vol %.

Exemplary methods also include, in the fixed bed operational configuration, providing a gasification input stream to the reactor. As discussed above, the gasification input stream may comprise carbon dioxide (CO₂) and methane (CH₄) or carbon dioxide (CO₂) and steam (H₂O). The gasification input stream contacts the oxygen carrier particles and thereby reduces the oxygen carrier particles. Exemplary methods also include collecting a second fixed bed configuration output comprising carbon monoxide (CO) and hydrogen (H₂).

In some implementations, after providing the gasification input stream to the reactor, exemplary methods include providing an oxidation stream to the reactor. The oxidation stream may comprise steam (H₂O). The oxidation stream contacts the oxygen carrier particles and oxidizes the oxygen carrier particles. Exemplary methods may additionally include collecting a third fixed bed configuration output comprising hydrogen (H₂).

In some implementations, the oxidation stream may comprise carbon dioxide (CO₂). The oxidation stream contacts the carbonaceous material deposited on inert particles and oxidizes the carbonaceous material. Exemplary methods may also include collecting a second fixed bed configuration output comprising carbon monoxide (CO). Exemplary carbonaceous material may comprise char, biochar, or other forms of carbonaceous material resulting from the pyrolysis of methane (CH₄) or a solid carbonaceous fuel.

In some implementations, a reactor in a fixed bed operational configuration may be operated at a temperature between 800° C. and 1000° C.; 825° C. and 1000° C.; 850° C. and 1000° C.; 875° C. and 1000° C.; 900° C. and 1000° C.; 925° C. and 1000° C.; 950° C. and 1000° C.; 975° C. and 1000° C.; 800° C. and 975° C.; 800° C. and 950° C.; 800° C. and 925° C.; 800° C. and 900° C.; 800° C. and 875° C.; 800° C. and 850° C.; or 800° C. and 825° C. In some implementations, the reactor in a fixed bed operational configuration may be operated at a temperature no less than 800° C.; no less than 825° C.; no less than 850° C.; no less than 875° C.; no less than 900° C.; no less than 925° C.; no less than 950° C.; no less than 975° C.; or no less than 1000° C. In some implementations, the reactor in a fixed bed operational configuration may be operated at a temperature no greater than 1000° C.; no greater than 975° C.; no greater than 950° C.; no greater than 925° C.; no greater than 900° C.; no greater than 875° C.; no greater than 850° C.; no greater than 825° C.; or no greater than 800° C.

### B. Fluidized Bed Operation

After fixed bed operation, operating in the fluidized bed operational configuration may begin by providing a fluidizing stream to the reactor. In some implementations, the fluidizing stream comprises air. The fluidizing stream is provided such that the oxygen carrier particles, or inert particles, form a fluidized bed in the reactor.

In some implementations, a fluidizing flow rate may have a superficial gas velocity corresponding to a U/U_{mf} value between 1.00 and 2.00; between 1.10 and 2.00; 1.21 and 2.00; 1.33 and 2.00; 1.44 and 2.00; 1.55 and 2.00; 1.66 and 2.00; 1.78 and 2.00; 1.89 and 2.00; 1.10 and 1.89; 1.10 and 1.78; 1.10 and 1.66; 1.10 and 1.55; 1.10 and 1.44; 1.10 and 1.33; or 1.10 and 1.21. In some implementations, a fluidizing flow rate may have a superficial gas velocity corresponding to a U/U_{mf} value no less than 1.0; no less than 1.10; no less than 1.21; no less than 1.33; no less than 1.44; no less than 1.55; no less than 1.66; no less than 1.78; no less than 1.89; or no less than 2.00. In some implementations, a fluidizing flow rate may have a superficial gas velocity corresponding to a U/U_{mf} value no greater than 2.00; no greater than 1.89; no greater than 1.78; no greater than 1.66; no greater than 1.55; no greater than 1.44; no greater than 1.33; no greater than 1.21; or no greater than 1.10.

In some implementations, oxygen carrier particles may be oxidized by the fluidizing stream. A fluidized bed configuration output may comprise oxygen-depleted air. Example methods may include monitoring a second target species content in the fluidized bed configuration output. When the second target species content deviates from a second threshold value, switching to the fixed bed operational configuration is initiated.

Exemplary methods may include monitoring oxygen (O₂) content in the fluidized bed configuration output.

When the second target species comprises oxygen (O₂), exemplary methods may include switching to the fixed bed operational configuration when the oxygen (O₂) content is above a second threshold value. In various instances, the second threshold value for oxygen (O₂) content may be no less than 75.0 vol %; no less than 78.1 vol %; no less than 81.3 vol %; no less than 84.4 vol %; no less than 87.5 vol %; no less than 90.6 vol %; no less than 93.8 vol %; no less than 96.9 vol %; or no less than 100.0 vol %.

In some implementations, when the second target species comprises char, switching to the fixed bed operational configuration may occur when the amount of char is less than a second threshold value. In various instances, when the second target species comprises char, switching to the fixed bed operational configuration may occur when the amount of char is no greater than 15.0 vol %; no greater than 13.1 vol %; no greater than 11.3 vol %; no greater than 9.4 vol %; no greater than 7.5 vol %; no greater than 5.6 vol %; no greater than 3.8 vol %; no greater than 1.9 vol %; or no greater than 0.0 vol %.

In implementations involving inert particles, providing a fluidizing stream to the reactor fluidizes the inert particles. During fluidizing operations, carbonaceous material on the inert particles may be oxidized. The fluidizing stream may comprise air, as discussed above. Example methods may further include collecting a fluidized bed configuration output comprising air, oxygen-depleted air, carbon dioxide (CO₂), and/or char.

In other instances, the fuel stream may comprise methane (CH₄), the first fixed bed configuration output may comprise hydrogen (H₂), and the fluidized bed configuration output may comprise air and char. Alternatively, the fuel stream may comprise a solid carbonaceous fuel, the first fixed bed configuration output may comprise carbonaceous volatiles, and the fluidized bed configuration output may comprise oxygen-depleted air and char.

In some instances, exemplary methods may include providing carbonaceous volatiles to a condenser unit. The condenser unit is configured to condense carbonaceous volatiles into bio-oil.

In some implementations, a reactor in a fluidized bed operational configuration may be operated at a temperature between 900° C. and 1030° C.; 916° C. and 1030° C.; 933° C. and 1030° C.; 949° C. and 1030° C.; 965° C. and 1030° C.; 981° C. and 1030° C.; 998° C. and 1030° C.; 1014° C. and 1030° C.; 900° C. and 1014° C.; 900° C. and 998° C.; 900° C. and 981° C.; 900° C. and 965° C.; 900° C. and 949° C.; 900° C. and 933° C.; or 900° C. and 916° C. In some implementations, the reactor in a fluidized bed operational configuration may be operated at a temperature no less than 900° C.; no less than 916° C.; no less than 933° C.; no less than 949° C.; no less than 965° C.; no less than 981° C.; no less than 998° C.; no less than 1014° C.; or no less than 1030° C. In some implementations, the reactor in a fluidized bed operational configuration may be operated at a temperature no greater than 1030° C.; no greater than 1014° C.; no greater than 998° C.; no greater than 981° C.; no greater than 965° C.; no greater than 949° C.; no greater than 933° C.; no greater than 916° C.; or no greater than 900° C.

### V. Experimental Data

Exemplary experiments are discussed below.

Experimental runs were carried out at two different temperatures, 900° C. and 950° C. The amount of oxygen carrier particles was kept the same in both runs.

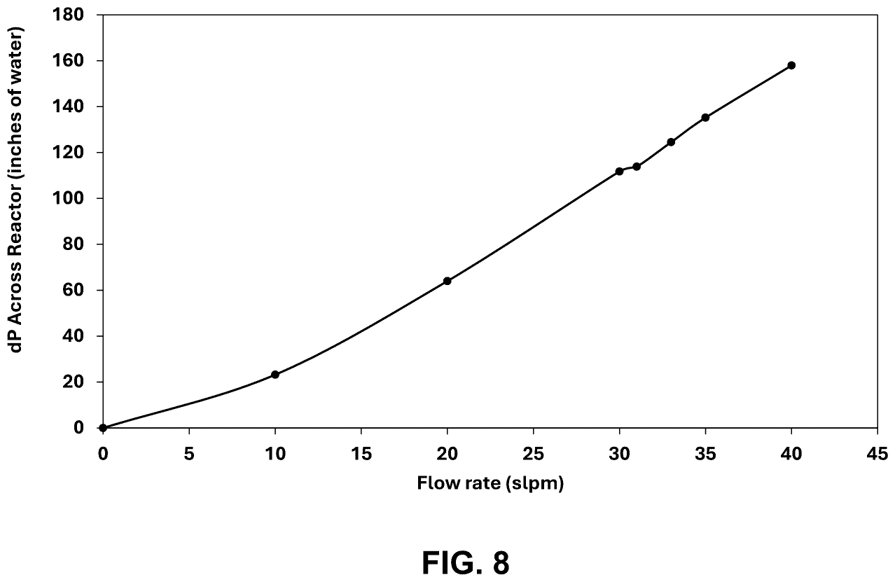

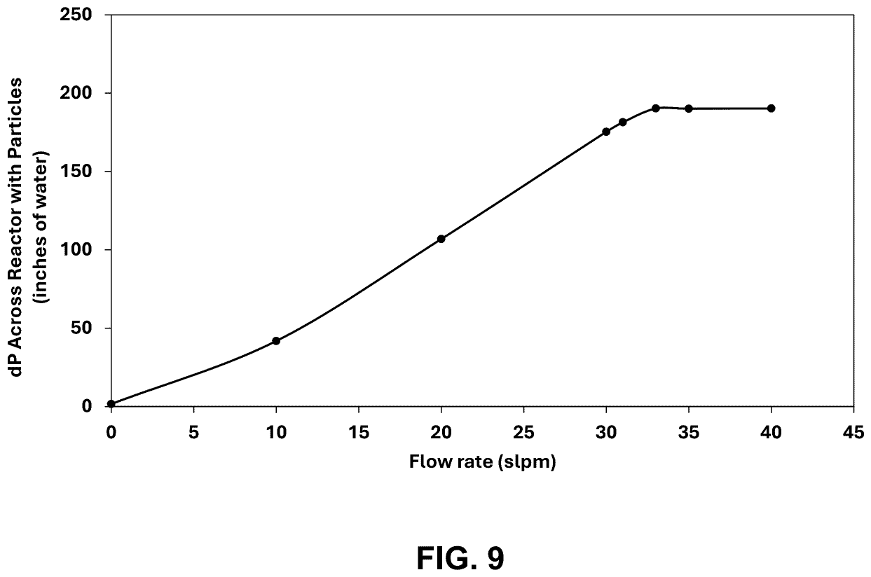

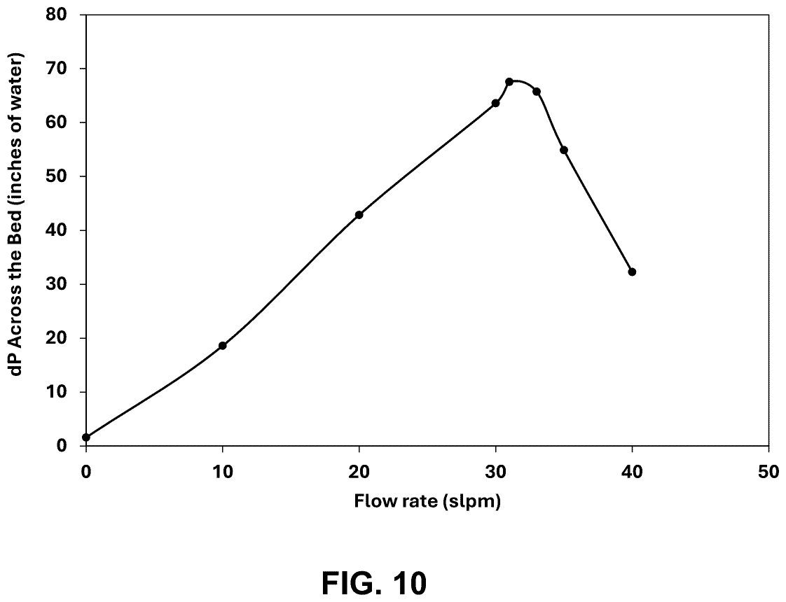

FIGS. 8-10 illustrate the flow rate required to fluidize the particles. The pressure drop versus flow rate plots showed that in a fixed bed state, the plot was almost linear. However, as soon as the minimum fluidization condition was reached and the particles were fluidized, the graph plateaued or started dropping. Consequently, 35 slpm (standard liters per minute) was used in the experimental runs for regenerating the particles with air under fluidized conditions.

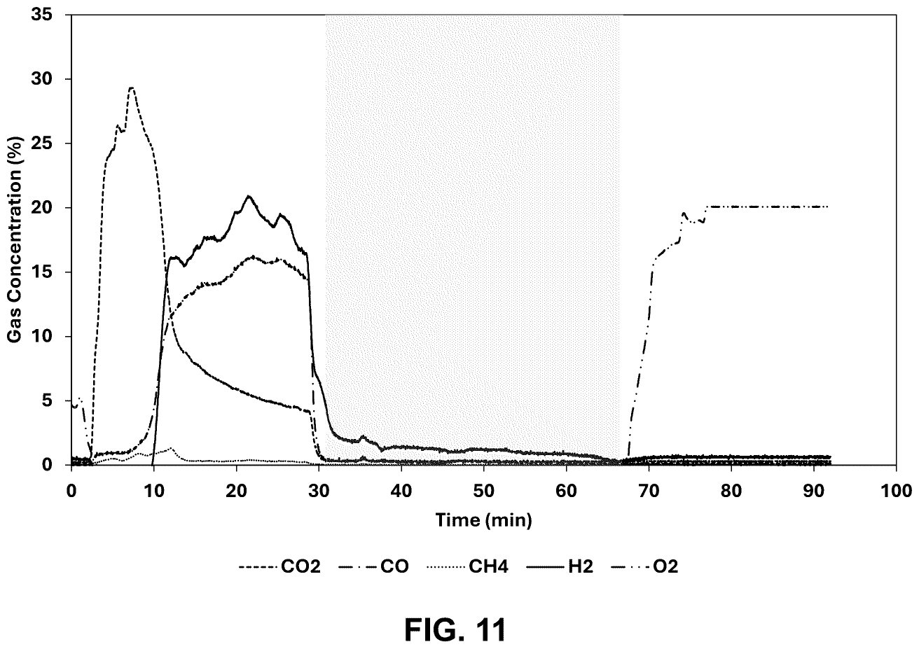

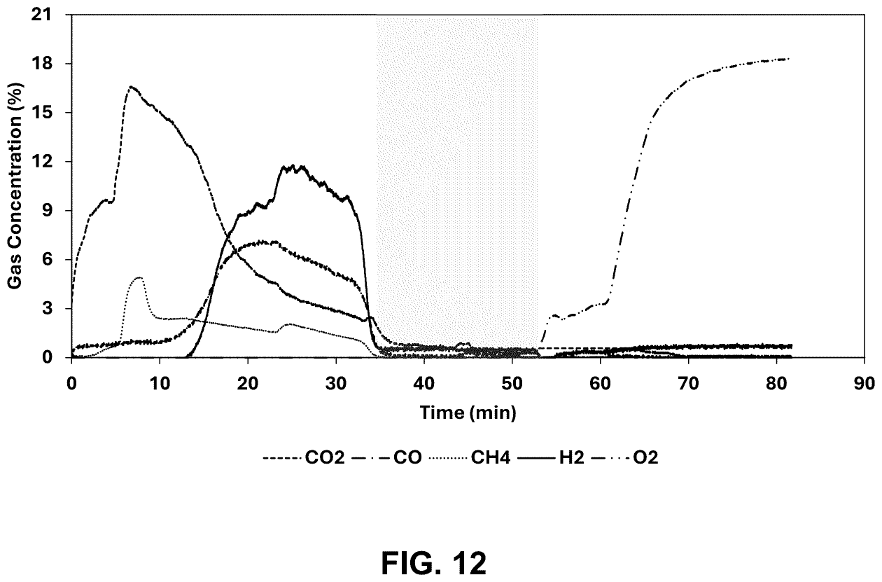

FIGS. 11 and 12 show that both experiments produced similar results. Fixed bed operating region 1 represents the presence of carbonaceous material and its subsequent reaction, while fixed bed operating region 2 represents the fluidized bed regeneration phase, and fixed bed operating region 3 represents the complete regeneration of the oxygen carrier particles with the onset of oxygen (O₂) at the reactor outlet.

In FIGS. 11 and 12, fixed-bed operating region 1 was marked by the presence of carbonaceous gases and their subsequent reaction. Further, in region 1, methane (CH₄—500 smlpm) was gasified into syngas with (CO₂—150 smlpm) as an additional gasifying agent.

In fixed-bed operating region 2 of FIGS. 11 and 12, the fixed bed was subjected to air as a regenerating medium with an air flow rate maintained above the minimum fluidization velocity of the particles (35 slpm) obtained through the hydrodynamic study above. Further, in this region, the monitored gases were not observed at the outlet because a lean stream of air was obtained at the outlet, consisting mainly of nitrogen (N₂), which was not monitored.

In fixed bed operating region 3 of FIGS. 11 and 12, oxygen (O₂) was observed at the reactor outlet, which marked the complete regeneration of the oxygen carrier particles.

The time used for the complete regeneration of the oxygen carrier particles when the reactor temperature was 950° C. was less than that used for 900° C. The shortened time was due to faster kinetics at 950° C. than at 900° C., which was exemplified by a shorter region 2 for the 950° C. run (FIG. 12, 20 minutes) than for the 900° C. run (FIG. 11, 30 minutes).

1. A method for operating a reactor, the method comprising:
in a fixed bed operational configuration:
providing a fuel stream to the reactor,
the fuel stream comprising methane (CH₄),
the reactor comprising oxygen carrier particles arranged as a fixed bed,
where the fuel stream is provided such that the fuel stream contacts the oxygen carrier particles, thereby reducing the oxygen carrier particles;
collecting a first fixed bed configuration output comprising carbon dioxide (CO₂) and steam (H₂O);
monitoring a target species purity in the first fixed bed configuration output; and
when the target species purity drops below a first threshold value of 85% purity, switching to a fluidized bed operational configuration;
after operating in the fixed bed operational configuration, in the fluidized bed operational configuration:
providing a fluidizing stream to the reactor, the fluidizing stream comprising air,
the fluidizing stream being provided such that the oxygen carrier particles form a fluidized bed in the reactor, whereupon the oxygen carrier particles are oxidized by the fluidizing stream;
collecting a fluidized bed configuration output comprising oxygen-depleted air;
monitoring oxygen (O₂) content in the fluidized bed configuration output; and
when the oxygen (O₂) content is above a second threshold value of 75%, switching to the fixed bed operational configuration.

2. The method of claim 1, the method further comprising:
in the fixed bed operational configuration, and after providing the fuel stream to the reactor:
providing a gasification input stream to the reactor, the gasification input stream comprising carbon dioxide (CO₂) and methane (CH₄),
the gasification input stream contacting the oxygen carrier particles and thereby further reducing the oxygen carrier particles;
collecting a second fixed bed configuration output comprising carbon monoxide (CO) and hydrogen (H₂);
after providing the gasification input stream to the reactor:
providing an oxidation stream to the reactor, the oxidation stream comprising steam (H₂O),
the oxidation stream contacting the oxygen carrier particles and oxidizing the oxygen carrier particles; and
collecting a third fixed bed configuration output comprising hydrogen (H₂).

3. The method of claim 1, the method further comprising:
in the fixed bed operational configuration, and after providing the fuel stream to the reactor:
providing a gasification input stream to the reactor, the gasification input stream comprising carbon dioxide (CO₂) and water (H₂O),
the gasification input stream contacting the oxygen carrier particles and thereby partially oxidizing the oxygen carrier particles;
collecting a second fixed bed configuration output comprising carbon monoxide (CO) and hydrogen (H₂);
after providing the gasification input stream to the reactor:
providing an oxidation stream to the reactor, the oxidation stream comprising steam (H₂O), the oxidation stream contacting the oxygen carrier particles and oxidizing the oxygen carrier particles; and
collecting a third fixed bed configuration output comprising hydrogen (H₂).

4. The method of claim 3, wherein the oxygen carrier particles comprise iron oxide (Fe₂O₃), copper oxide (CuO), nickel oxide (NiO), manganese oxide (Mn₂O₃), cerium oxide (CeO₂), cobalt oxide (Co₃O₄), tungsten oxide (WO₃), vanadium oxide (V₂O₅), calcium and iron oxide (Ca₂Fe₂O₅), or combinations thereof.

5. The method of claim 1, wherein oxygen-depleted air comprises between 3% and 5% oxygen (O₂) by volume; and
wherein the target species comprises one of: carbon dioxide (CO₂), steam (H₂O), carbon monoxide (CO), or hydrogen (H₂).

6. A reactor system, comprising:
a reactor having a fixed bed operational configuration and a fluidized bed operational configuration, the reactor comprising:
particles that are oxygen carrier particles or inert particles arranged as a fixed bed during the fixed bed operational configuration;
wherein the fixed bed occupies between 40 volume percent (vol %) and 60 vol % of an inner volume of the reactor;
a fuel stream inlet configured to receive fuel from a fuel stream input source;
a first outlet configured to provide a first output stream during the fixed bed operational configuration;
a fluidizing stream inlet configured to receive a fluidizing stream from a fluidizing stream input source; and
a second outlet configured to provide a second output stream during the fluidized bed operational configuration.

7. The reactor system of claim 6, wherein the particles are oxygen carrier particles and wherein the reactor system further comprises:
a gasification stream inlet configured to receive a gasification stream from a gasification input source; and
an oxidation stream inlet configured to receive an oxidation stream from an oxidation stream source.

8. The reactor system of claim 6, wherein the particles are inert particles and wherein the reactor system further comprises:
an oxidation stream inlet configured to receive an oxidation stream from an oxidation input source.

9. The reactor system of claim 6, wherein the particles are inert particles and wherein the reactor system further comprises:
a barrier stream inlet configured to receive a barrier stream from a barrier stream source;
and a condenser configured to receive a fixed bed configuration output stream and configured to provide bio-oil.

10. The reactor system of claim 6, wherein the oxygen carrier particles comprise iron oxide (Fe₂O₃), copper oxide (CuO), nickel oxide (NiO), manganese oxide (Mn₂O₃), cerium oxide (CeO₂), cobalt oxide (Co₃O₄), tungsten oxide (WO₃), vanadium oxide (V₂O₅), calcium and iron oxide (Ca₂Fe₂O₅), or combinations thereof; and
wherein the inert particles are not reactants in either reduction or oxidation reactions and include SiO₂, Al₂O₃, aluminosilicates, kaolin, mullite, alumina-zirconia-silica, CaAl₂O₄, CaAl₄O₇, or combinations thereof.

11. The reactor system of claim 6, further comprising an analyzer unit in communication with the first outlet and the second outlet, the analyzer unit configured to determine concentrations of one or more target species in the first output stream and/or the second output stream.

12. A method for operating a reactor, the method comprising:
in a fixed bed operational configuration:
providing a fuel stream to the reactor,
the fuel stream comprising methane (CH₄) and/or a solid carbonaceous fuel,
the reactor comprising inert particles;
collecting a first fixed bed configuration output comprising hydrogen (H₂) and/or carbonaceous volatiles;
monitoring a target species purity in the first fixed bed configuration output; and
when the target species purity drops below a first threshold value of 85% purity, switching to a fluidized bed operational configuration;
after the fixed bed operational configuration, in the fluidized bed operational configuration:
providing a fluidizing stream to the reactor, such that the fluidizing stream fluidizes the inert particles and carbonaceous material on the inert particles is oxidized;
the fluidizing stream comprising air, and
collecting a fluidized bed configuration output comprising air, oxygen-depleted air, carbon dioxide (CO₂), and/or char;
monitoring a second target species content in the fluidized bed configuration output; and
when the second target species content deviates from a second threshold value, switching to the fixed bed operational configuration.

13. The method of claim 12, wherein the fuel stream comprises methane (CH₄), the first fixed bed configuration output comprises hydrogen (H₂), and the fluidized bed configuration output comprises oxygen-depleted air and carbon dioxide (CO₂), the method further comprising:
in the fixed bed operational configuration, and after providing the fuel stream to the reactor:
providing an oxidation stream to the reactor, the oxidation stream comprising carbon dioxide (CO₂) and contacting the inert particles, wherein carbonaceous material on the inert particles is oxidized; and
collecting a second fixed bed reactor output comprising carbon monoxide (CO).

14. The method of claim 12, wherein the fuel stream comprises methane (CH₄), the first fixed bed configuration output comprises hydrogen (H₂), and the fluidized bed configuration output comprises air and char.

15. The method of claim 12, wherein the fuel stream comprises a solid carbonaceous fuel, the first fixed bed configuration output comprises carbonaceous volatiles, and the fluidized bed configuration output comprises carbon dioxide (CO₂) and oxygen-depleted air or air and char, the method further comprising:
during the fixed bed operational configuration, providing a barrier stream adjacent to an interface of a pyrolyzing region and a gasifying region of the reactor, the barrier stream comprising an inert gas.

16. The method of claim 15, the method further comprising:
providing carbonaceous volatiles to a condenser, the condenser configured to condense carbonaceous volatiles into bio-oil.

17. The method of claim 12, wherein the inert particles are not reactants in either reduction or oxidation reactions and include SiO₂, Al₂O₃, aluminosilicates, kaolin, mullite, alumina-zirconia-silica, CaAl₂O₄, CaAl₄O₇, or combinations thereof.

18. The method of claim 15, wherein an inert gas comprises nitrogen (N₂), argon (Ar), neon (Ne), helium (He), or combinations thereof.

19. The method of claim 12, wherein solid carbonaceous fuel comprises biomass, plastics, coal, municipal solid waste, or combinations thereof; and
wherein oxygen-depleted air comprises between 3% and 5% oxygen (O₂) by volume.

20. The method of claim 12, wherein when the second target species comprises char, switching to the fixed bed operational configuration occurs when the second threshold value is less than 15%; and
when the second target species comprises oxygen (O₂), switching to a fixed bed operational configuration occurs when the second threshold value is more than 85%.
